(19) United States
(12) Patent Application Publication
(10) Pub. No.: US 2013/0222536 A1
(43) Pub. Date: Aug. 29, 2013

(54) 3D GLASSES, 3D IMAGE DISPLAY APPARATUS AND A CONTROL METHOD THEREOF

(71) Applicant: Kabushiki Kaisha Toshiba, (US)

(72) Inventor: Kazuya Hanabusa, Kumagaya-shi (JP)

(73) Assignee: KABUSHIKI KAISHA TOSHIBA, Tokyo (JP)

(21) Appl. No.: 13/777,756

(22) Filed: Feb. 26, 2013

(30) Foreign Application Priority Data
Feb. 29, 2012 (JP) 2012-044805

(51) Int. Cl. H04N 13/00

(52) U.S. Cl. CPC H04N 13/0007
USPC 348/43

(57) ABSTRACT

According to one embodiment, a 3D glasses apparatus for displaying a 3D image includes: a measurement module configured to measure a size of a user's head by using left and right legs of the 3D glasses apparatus when a user uses the 3D glasses apparatus; and a detection module configured to detect whether a measurement value measured by the measurement module is smaller than a reference value; and a controller configured to control a 3D image signal not to be displayed in accordance with the judgment result of the detection module.

### CROSS REFERENCE TO RELATED APPLICATION(S)

The application is based upon and claims the benefit of priority from Japanese Patent Application No. 2012-044805 filed on Feb. 29, 2012; the entire contents of which are incorporated herein by reference.

### FIELD

Embodiments described herein relate generally to a three dimensional (3D) glasses, a 3D image display apparatus, and a control method thereof.

### BACKGROUND

In the related art, a 3D image display apparatus has been existed such as a TV broadcast receiving device which can provide a 3D image to a user by using two images having a disparity corresponding to an inter-ocular distance. The related device for displaying a 3D image allows a user who wears the 3D glasses to recognize the 3D image in such a manner that a right-eye image and a left-eye image are alternately displayed to control the opening and closing of a left-eye shutter and a right-eye shutter provided in the 3D glasses based on the image display timing

However, there is a possibility that viewing the 3D image will influence the growth of a child.

### BRIEF DESCRIPTION OF THE DRAWINGS

Exemplary embodiments of the present invention will be described in detail based on the following figures, wherein:

FIG. 1 is a diagram illustrating a 3D image display system in a case where a user views a screen;

FIG. 2 is a diagram illustrating a configuration of a digital TV broadcast receiving device;

FIG. 3 is a diagram illustrating a configuration of a synthesis processing module illustrated in FIG. 2;

FIG. 4 is a diagram illustrating a configuration of 3D glasses;

FIG. 5 is a diagram illustrating a processing flow of controlling a 3D viewing function from the 3D glasses; and

FIG. 6 is a diagram illustrating a processing flow of controlling the 3D viewing function from the digital TV broadcast receiving device.

### DETAILED DESCRIPTION OF THE EXEMPLARY EMBODIMENTS

According to one embodiment, a 3D glasses apparatus for displaying a 3D image includes: a measurement module configured to measure a size of a user's head by using left and right legs of the 3D glasses apparatus when a user uses the 3D glasses apparatus; and a detection module configured to detect whether a measurement value measured by the measurement module is smaller than a reference value; and a controller configured to control a 3D image signal not to be displayed in accordance with the judgment result of the detection module.

Hereinafter, exemplary embodiments of the present invention will be described in detail with reference to the accompanying drawings. Further, a plurality of exemplary embodiments as described below includes the same constitutional elements. Accordingly, hereinafter, common reference numerals are given to the same constitutional elements and a duplicated description thereof will be omitted.

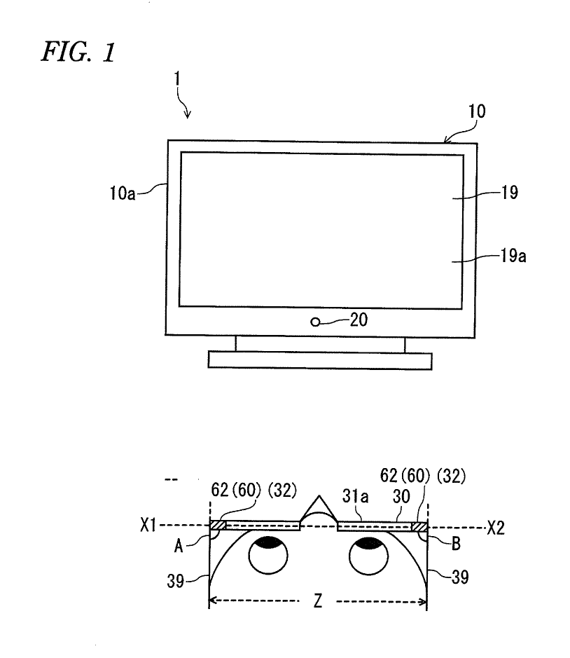

FIG. 1 illustrates a 3D image display system according to an exemplary embodiment when a viewer views a screen. The 3D image display system 1 includes a digital TV broadcast receiving device (main device) 10 serving as a 3D image display apparatus and 3D glasses 30. In the 3D image display system 1, the viewer may experience a stereo vision by viewing a 3D image output on a screen of the digital TV broadcast receiving device 10 while wearing the 3D glasses 30.

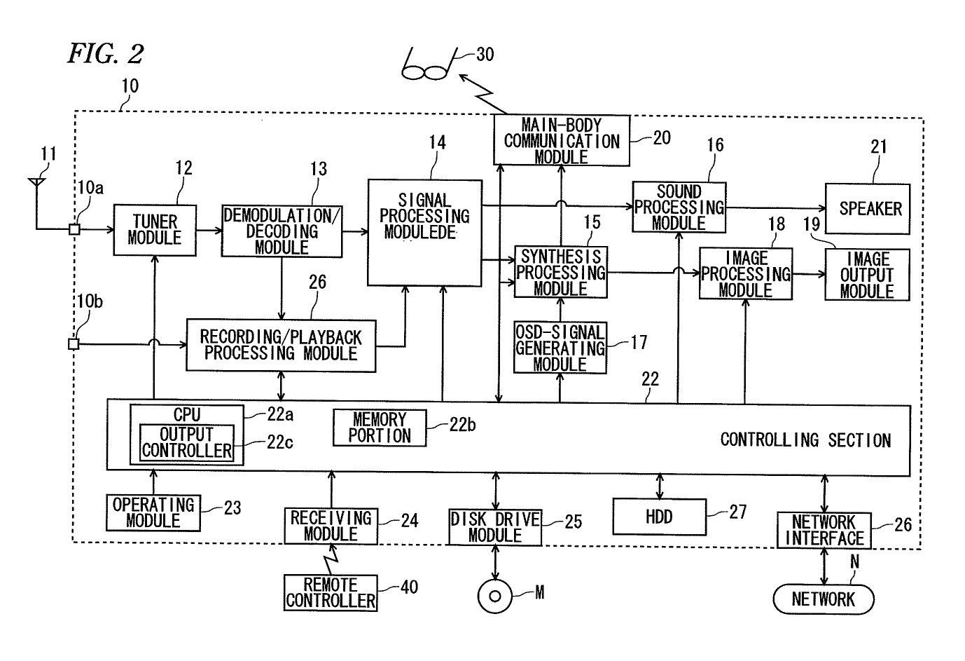

FIG. 2 illustrates a configuration of the digital TV broadcast receiving device according to the exemplary embodiment. The digital TV broadcast receiving device 10 is an image display device that displays an image based on a general 2D image signal and an image based on a 3D image signal.

A digital TV broadcast signal received at an antenna 11 is supplied to a tuner module 12 through an input terminal 10a to select a broadcast signal of a desired channel. The broadcast signal selected by the tuner module 12 is supplied to a demodulation/decoding module 13 to be restored to a digital image signal and a digital sound signal, and thereafter, output to a signal processing module 14.

The signal processing module 14 performs a predetermined digital signal processing of the digital image signal and sound signal supplied from the demodulation/decoding module 13. The predetermined digital signal processing performed by the signal processing module 14 includes a processing of converting the image signal for displaying the general planar 2D image into the image signal for displaying the 3D image or a processing of converting the image signal for displaying the 3D image into the image signal for displaying the general planar 2D image. The signal processing module 14 outputs the digital image signal to a synthesis processing module 15 and outputs the digital sound signal to a sound processing module 16.

The synthesis processing module 15 overlaps the digital image signal supplied from the signal processing module 14 with an on screen display (OSD) signal generated by an OSD signal generating module 17 and outputs the overlapped signal. In this case, when the image signal supplied from the signal processing module 14 is the image signal for displaying the general 2D image, the synthesis processing module 15 overlaps the OSD signal supplied from the OSD signal generating module 17 with the image signal as it is and outputs the overlapped signal.

When the image signal supplied from the signal processing module 14 is the image signal for displaying the 3D image, the synthesis processing module 15 performs signal processing for displaying the 3D view corresponding to the input image signal for displaying the 3D image with respect to the OSD signal supplied from the ODS signal generating module 17 and thereafter, overlaps the OSD signal with the input image signal and outputs the overlapped signal.

The digital image signal output from the synthesis processing module 15 is supplied to an image processing module 18 which converts the input digital image signal into an analog image signal of a format to be displayed through, for example, a flat type image output module 19 at a rear end having a liquid crystal display panel. The analog image signal output from the image processing module 18 is supplied to the image output module 19, which outputs the image onto a screen 19a. The image output module 19 may be configured to selectively output (display) one of a 2D image and a 3D image.

A main-body communication module 20, which is connected to the synthesis processing module 15, transmits each of left-eye and right-eye shutter control signals output from a glasses controller 159 to be described below to 3D glasses 30. A communication method of the main-body communication module 20 may use irrespective of for example, Bluetooth (registered trademark) or an infrared communication method, a DLP-LINK (registered trademark) method and the like.

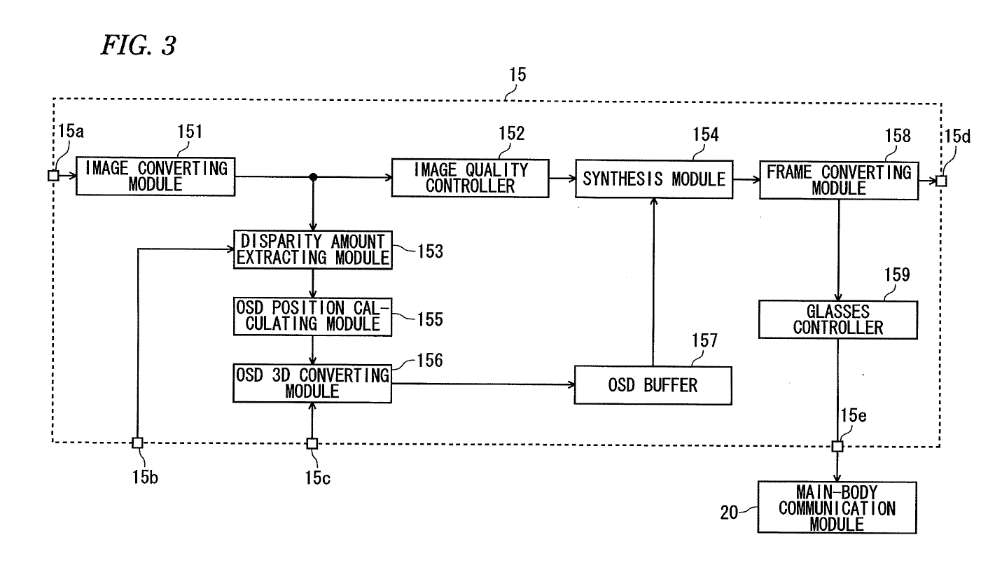

Herein, FIG. 3 illustrates a configuration of the synthesis processing module 15. The digital image signal output from the signal processing module 14 is supplied to an image converting module 151 through an input terminal 15a. When the input image signal is the image signal for displaying the stereoscopic 3D image, the image converting module 151 converts the image signal into a predetermined image format and outputs the signal with the converted format to an image quality controller 152 and a disparity amount extracting module 153.

In the image signal for displaying the 3D image, various image formats are provided including a frame packing type of transmitting a right-eye image frame after a left-eye image frame within one synchronization period of frame or a side-by-side type of transmitting a right-eye image line after a left-eye image line within one horizontal period. Even among the respective image formats, various image sizes or scanning methods (interlaced/progressive) are provided.

As a result, in the exemplary embodiment, the image converting module 151 performs processing such as scaling processing or interlace/progressive (IP) conversion processing with respect to the input image signal for displaying the 3D image to convert the processed signal into the frame packing type image format having a predetermined image size (for example, horizontal 1920 pixels×vertical 1080 lines) and synchronize the converted image format with a vertical synchronization signal. The synchronized signal is then output to the image quality controller 152 and the disparity amount extracting module 153.

The image quality controller 152 performs image quality adjustment processing such as brightness adjustment, contrast adjustment, and color adjustment based on a control of a main-body controller 22 with respect to the input image signal and synchronizes the image signal subjected to the image quality adjustment processing with the vertical synchronization signal. The synchronized signal is then output to a synthesis module 154.

The disparity amount extracting module 153 extracts a disparity amount by comparing images between the left-eye image frame and the right-eye image frame with respect to the image signal for displaying the 3D image converted into the frame packing type image format by the image converting module 151.

The extraction processing of the disparity amount by the disparity amount extracting module 153 is performed by expressing horizontal position aberration of the same object displayed in the right-eye image frame as the number of pixels based on the position of an object displayed in the left-eye image frame. The extraction processing of the disparity amount may be easily implemented by using a technique of a motion vector for detecting a motion position of the same object displayed by successive frames. In detail, a number of a pixel at the same predetermined position of an object displayed in the right-eye image frame is subtracted from a number of a pixel at a predetermined position of the object displayed in the left-eye image frame by numbering pixels arranged horizontally on the screen from the left side to the right side, thereby expressing the disparity amount as the number of pixels.

In this case, when the disparity amount has a negative value, the right-eye image is provided further at a right side than the left-eye image, and the object becomes an image formed inside the screen. When the disparity amount has a positive value, the right-eye image is provided further at a left side than the left-eye image, such that the object becomes an image formed in front of the screen.

The disparity amount extracting module 153 switches the value of the disparity amount to a zero value according to the control signal from the main-body controller 22, which is input through an input terminal 15b. Herein, in a state in which the disparity amount is zero, the left-eye image and the right-eye image are present at the same position together, such that the images become images formed on the screen, that is, the planar 2D image.

The disparity amount extracted by the disparity amount extracting module 153 is supplied to an OSD position calculating module 155. The OSD position calculating module 155 performs calculation of correcting a display position at the time of displaying an OSD signal in stereoscopic 3D image based on the input disparity amount and outputs a disparity control signal indicating the calculation result.

In detail, the OSD position calculating module 155 performs the calculation of correcting the display position at the time of 3D-displaying the OSD signal in stereoscopic 3D image when the disparity amount extracted by the disparity amount extracting module 153 is not changed on a time-axis or in an image display state in which the disparity amount is gently changed along a time-axis direction. That is, when the disparity amount is significantly changed in the time-axis direction, the image moves inward heavily, and since a user concerns about the image in this state, it is difficult to view even overlapped OSDs when the overlapped OSDs move inward heavily. Therefore, the OSD position calculating module 155 outputs a disparity control signal indicating a result calculated when variation of the disparity amount is small in the state in which the disparity amount is changed heavily. In the state in which the disparity amount has the zero value, the display position is not corrected.

The disparity control signal output from the OSD position calculating module 155 is supplied to an OSD 3D converting module 156. The OSD signal output from the QSD signal generating module 17 is supplied to the OSD 3D converting module 156 through an input terminal 15c. The OSD 3D converting module 156 generates a left-eye OSD signal overlapped with the left-eye image frame and a right-eye OSD signal overlapped with the right-eye image frame from the input OSD signal, based on the disparity control signal and outputs and stores both of the generated signals to and in an OSD buffer 157.

The image signal synthesized by the synthesis module 154 is supplied to a frame converting module 158, and a vertical synchronization frequency is converted twice, that is, a frame frequency is made into double rate, and thereafter, the frame frequency made into double rate is output to an image output module 19 through the image processing module 18 at an output terminal 15d. As a result, the image output module 19 outputs onto the screen 19a a 3D image in which the left-eye image and the right-eye image are alternately switched.

A frame synchronization signal generated by the frame converting module 158 is supplied to the glasses controller 159. The glasses controller 159 generates the left-eye and right-eye shutter control signals in synchronization with the frame synchronization signal supplied from the frame converting module 158 and outputs the generated signals to the 3D glasses 30 through the main-body communication module 20 at an output terminal 15e.

Referring back to FIG. 2, the sound processing module 16 converts the digital sound signal input from the signal processing module 14 into an analog sound signal of a format to be played back through a speaker (sound outputting module) 21. The analog sound signal output from the sound processing module 16 is supplied to the speaker 21, and as a result, the speaker 21 plays back and outputs sound.

As illustrated in FIGS. 1 and 2, the main-body communication module 20 is installed at a lower part of the screen 19a of the digital TV broadcast receiving device 10.

Herein, in the digital TV broadcast receiving device 10, all operations including various receiving operations described above are comprehensively managed and controlled by the main-body controller 22. The main-body controller 22 incorporates a central processing module (CPU) 22a therein and receives operation information from an operating module 23 installed in a main body of the digital TV broadcast receiving device 10 or receives operation information transmitted from the remote controller 40 and received by a receiving module 24 to control the respective modules so as to reflect the operation contents. The main-body controller 22 controls the image output module 19 or the speaker 21 according to a detection result of a detection module 600.

In this case, the main-body controller 22 uses a memory portion 22b. The memory portion 22b includes a read only memory (ROM) primarily storing a control program executed by the CPU 22a, a random access memory (RAM) for providing a working space to the corresponding CPU 22a and a non-volatile memory storing various kinds of pieces of setting information and control information.

A disk drive module 25 is connected to the main-body controller 22. The disk drive module 25 enables an optical disk M such as a digital versatile disk (DVD) to be arbitrarily mounted/demounted and serves to record/play back digital data with respect to the mounted optical disk M.

The main-body controller 22 may control such that the digital image signal and sound signal acquired by the demodulation/decoding module 13 by a recording/playback processing module 26 are encrypted, the encrypted signals are converted into signals of a predetermined record format and the signals of the predetermined record format are supplied to the disk drive module 25 to be recorded in the optical disk M, based on an operation of the operating module 23 or the remote controller 40 by a user.

The main-body controller 22 may control such that the digital image signal and sound signal from the optical disk M by the disk drive module 25 are read-out, the read-out signals are decoded by the recording/playback processing module 26, and the decoded signals are supplied to the signal processing module 14 to be subjected to the image display and sound playback, based on an operation of the operating module 23 or remote controller 40 by a user.

A hard disk drive (HDD) 27 is connected to the main-body controller 22. The main-body controller 22 may control such that the digital image signal and sound signal acquired by the demodulation/decoding module 13 by the recording/playback processing module 26 are encrypted and the encrypted signals are converted into signals of a predetermined record format to be recorded in the HDD 27, based on an operation of the operating module 23 or remote controller 40 by a user.

The main-body controller 22 may control such that the digital image signal and sound signal from the HDD 27 are read-out, the read-out signals are decoded by the recording/playback processing module 26 and thereafter, the decoded signals are supplied to the signal processing module 14 to be subjected to the image display and sound playback, based on an operation of the operating module 23 or remote controller 40 by a user.

An input terminal 10b is connected to the digital TV broadcast receiving device 10. The input terminal 10b is used to directly input the digital sound image signal and sound signal outside the digital TV broadcast receiving device 10. The digital image signal and sound signal input through the input terminal 10b are supplied to the signal processing module 14 after passing through the recording/playback processing module 26 and thereafter, provided to the image display and sound playback, based on a control of the main-body controller 22.

The digital image signal and sound signal input through the input terminal 10b are provided to recording/playback with respect to the optical disk M by the disk driver module 25 or recording/playback with respect to the HDD 27 after passing through the recording/playback processing module 26, based on the control of the main-body controller 22.

The main-body controller 22 controls even recording of the digital image signal and sound signal recorded in the optical disk M in the HDD 27 or recording of the digital image signal and sound signal recorded in the HDD 27 in the optical disk M, between the disk driver 25 and the HDD 27, based on an operation of the operating module 23 or the remote controller 40 by a user.

A network interface 28 is connected to the main-body controller 22. The network interface 28 is connected to an external network N. The network interface 28 communicates with an external device, which is not illustrated, through the network N. As a result, the main-body controller 22 may use a service provided by performing information-communication with accessing the external device connected to the network N through the network interface 28.

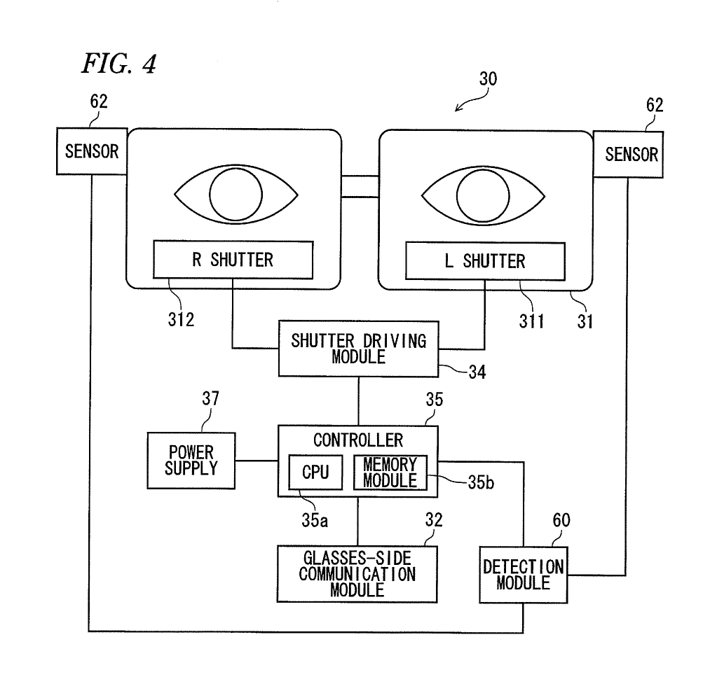

Next, the 3D glasses 30 will be described with reference to FIG. 4. FIG. 4 is a diagram illustrating a configuration of the 3D glasses 30 according to the exemplary embodiment.

The 3D glasses 30 are used for the 3D image output by the image output module 19 of the digital TV broadcast receiving device 10. In detail, the 3D glasses 30 opens and closes the right shutter of the 3D glasses for a vision of a right eye in synchronization with output and non-output of the right-eye image as well as opens and closes the left shutter of the 3D glasses for a vision of a left eye in synchronization with output and non-output of the left-eye image. As illustrated in FIG. 4, the 3D glasses 30 includes a liquid crystal shutter glasses 31, a glasses-side communication module 32, a shutter driving module 34, a sensor 62 that measures a width between left and right legs 39 of the 3D glasses 30 or angles between a lens surface of the glasses and the legs 39 (to be described below in detail), a detection module (judgment means) 60, and a controller 35.

The 3D glasses 30 is mounted with a power supply 37 such as a battery, and the like and operated by power supplied from the power supply 37.

The liquid crystal shutter glasses 31 include a left-eye liquid crystal shutter (L shutter) 311 for shuttering the left eye on and off and a right-eye liquid crystal shutter (R shutter) 312 for shuttering the right eye on and off. The user views the alternately displayed left-eye image and right-eye image with the left eye and the right eye alternately by wearing the liquid crystal shutter glasses 31 (3D glasses 30) to experience the 3D view.

The glasses-side communication module 32 as a receiving device corresponding to a transmission method of the main-body communication module 20 receives the left-eye and right-eye shutter control signals transmitted form the main-body communication module 20 of the digital TV broadcast receiving device 10.

The shutter driving module 34, which opens/closes the L shutter 311 and the R shutter 312 according to the control signal input from the controller 35, implements a transparent state and an opaque state of the image (light) displayed in the digital TV broadcast receiving device 10.

The controller 35 comprehensively manages and controls the operation of each module. The controller 35 incorporates a CPU 35a or a memory module 35b therein. The memory module 35b primarily includes a ROM storing a control program executed by the CPU 35a, a RAM for providing a working area to the CPU 35a and a non-volatile memory storing various kinds of pieces of setting information and control information.

The controller 35 controls opening and closing of the L shutter 311 and the R shutter 312 based on the left-eye and right-eye shutter control signals input from the glasses communication module 32. Specifically, the controller 35 opens and closes the R shutter 312 to enable and disable the right eye view images to be presented to the R shutter in synchronization with output and non-output of the right-eye image as well as opens and closes the L shutter 31 to enable and disable the left eye view images to be presented to the L shutter in synchronization with output and non-output of the left-eye image, based on the shutter control signal. The controller 35 transmits the judgment result input from the detection module 60 to the main-body communication module 20 of the digital TV broadcast receiving device 10 by using the glasses communication module 32.

The sensor 62 has both a pressure sensor and an angle sensor as the exemplary embodiment, and as illustrated in FIG. 1, the sensors 62 are spaced apart from each other in a horizontal direction of the 3D glasses 30 and fixed to a frame 31a. In some cases, the sensor 62 may be only the pressure sensor or only the angle sensor. The sensor 62 may be a sensor other than the pressure sensor or the angle sensor. Herein, the 3D glasses 30 is described as the shutter type device, but the shutter type device is just one example of the 3D glasses 30, and the 3D glasses 30 may be, of course, other types devices such as a linearly-polarized filter type, and the like.

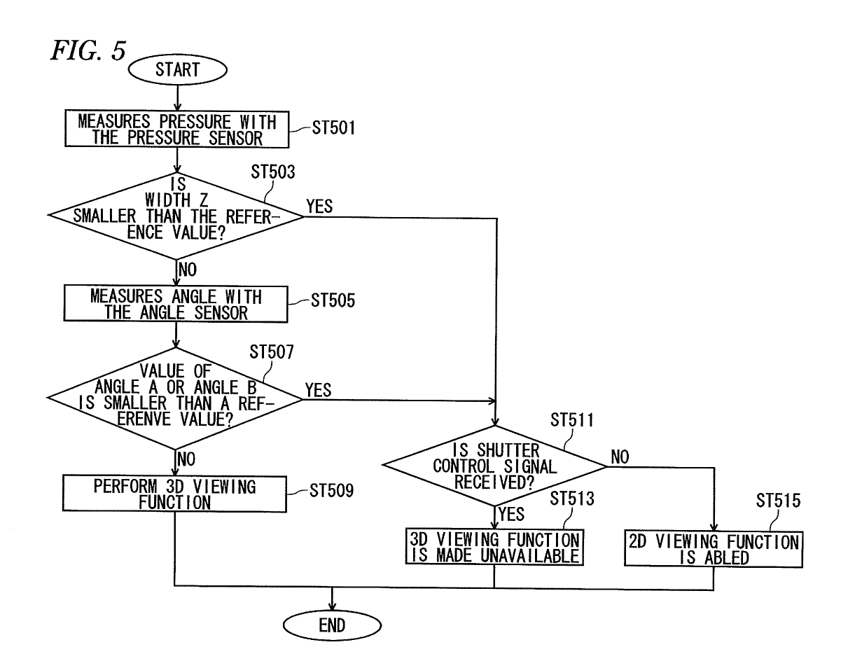

Hereinafter, a processing flow of controlling a 3D viewing function at the 3D glasses 30 is illustrated in FIG. 5.

For example, when the 3D glasses 30 is mounted on a user's head (ear), the pressure sensor measures the pressure of the left and right legs 39 and the user's head and transmits the measurement result to the detection module 60 (step ST501). That is, the pressure sensor measures a width Z (illustrated in FIG. 1) between the left leg 39 and the right leg 39. The detection module 60 compares a reference value sent from the controller 35 with the measurement value (width Z) measured by the pressure sensor to detect whether the measurement value (width Z) is smaller than the reference value (step ST503). When it is detected that the measurement value (width Z) is smaller than the reference value (“Yes” at step ST503), the process proceeds to processing of step ST511.

When the detection module 60 detects that the measurement value (width Z) is larger than the reference value (“No” at step ST503), the angle sensor measures an angle A and an angle B between the lens surface (represented as line X1-X2 of FIG. 1) and the legs 39 of the glasses 30. When the detection module 60 detects that a measurement value (the angle A or the angle B) is smaller than a reference value (“Yes” at step ST507), the process proceeds to the processing of step ST511. When the detection module 60 detects that the measurement value (the angle A or the angle B) is larger than the reference value (“No” at step ST507), the detection module 60 notifies the judgment result to the controller 35, and the controller 35 receives the notification to detect that the user is an adult. When the shutter control signal is sent from the digital TV broadcast receiving device 10, the controller 35 detects that the 3D viewing function on the digital TV broadcast receiving device 10 is available, thereby performing the 3D viewing function. That is, the controller 35 controls opening and closing of the L shutter 311 and the R shutter 312 through the shutter driving module 34 based on the left-eye and right-eye shutter control signals input from the glasses communication module 32.

Next, the process returns to the processing of step ST511. When the detection module 60 detects that the measurement value (width Z) is smaller than the reference value or the measurement value (the angle A or the angle B) is smaller than the reference value, the detection module 60 notifies the judgment result to the controller 35. The controller 35 receives the notification to detect that the user is a child. The controller 35 identifies whether the digital TV broadcast receiving device 10 receives the shutter control signal. When the digital TV broadcast receiving device 10 receives the shutter control signal (“Yes” at step ST511), the controller 35 detects that the received shutter control signal is a 3D image signal and controls the L shutter 311 and the R shutter 312 not to be opened/closed through the shutter driving module 34 so as to make the 3D viewing function unavailable. By this configuration, although the viewer receives the 3D image signal from the digital TV broadcast receiving device 10, the viewer cannot view the 3D images.

When the digital TV broadcast receiving device 10 does not receive the shutter control signal (“No” in step ST511), the controller 35 detects that the 3D viewing function at the digital TV broadcast receiving device 10 is unavailable and enables 2D viewing (step ST515).

As such, when the 3D image signal is viewed by using the 3D glasses, the width between the left and right legs 39 of the glasses 30 or the angle A and the angle B are detected. When the detected width or angles A and b are smaller than the reference value (the width of the head is small), it is detectd that the user is child, and the 3D viewing function is made unavailable to prevent the child from viewing the 3D images.

FIG. 5 is one example of a judgment condition as to whether the 3D viewing function will be available or unavailable. If even the width of the legs 39 or even any one of the angles A and B corresponds to a condition defined as described above in this example, the 3D viewing function is made unavailable. However, it does not matter although the judgment condition is not limited thereto, and for example, the judgment may be made based on only any one of the width of the legs 39 and the angles A and B or the judgment may be made by prioritizing over any one detection result. Even when any one of the angles A and B is smaller than the reference value, the 3D viewing function is made unavailable.

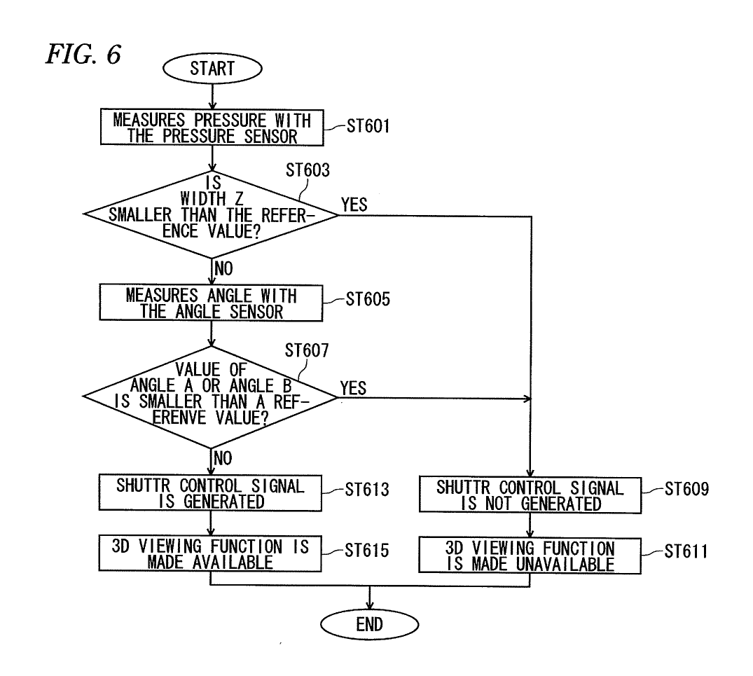

Next, a processing flow of controlling the 3D viewing function on the digital TV broadcast receiving device 10 is illustrated in FIG. 6.

The processing of steps ST601 to ST607 of FIG. 6 is the same as the processing of steps ST501 to ST507 described in FIG. 5. Therefore, a description thereof will be omitted.

At step ST603 or ST607, when the detection module 60 detects that the measurement value (the width Z or the angles A and B) is smaller than the reference value, the detection module 60 notifies the judgment result to the controller 35, and the controller 35 detects that the user is the child. The controller 35 notifies the judgment result to the main-body communication module 20 of the digital TV broadcast receiving device 10 through the glasses communication module 32. When the judgment result is notified from the main-body communication module 20 to the main-body controller 22, the main-body controller 22 controls the synthesis processing module 15 not to generate the shutter control signal (step ST609). An output controller 22c in the main-body controller 22 controls the 3D viewing not to be allowed by stopping the 3D image signal (output) of the image output module 19. That is, the 3D viewing function is made unavailable (step ST611).

Next, when it is detected to be “No” at step ST607, the controller 35 (of the 3D glasses 30) detects that the user is the adult to notify the judgment result to the main-body communication module 20 of the digital TV broadcast receiving device 10 through the glasses communication module 32. The main-body communication module 20 (of the broadcast receiving device 10) notifies the judgment to the main-body controller 22. When the information that the user is the adult is notified to the main-body controller 22, the main-body controller 22 controls the synthesis processing module 15 to generate the shutter control signal (step ST613). The output controller 22c of the main-body controller 22 controls the image output module 19 to output the 3D image signal. That is, the 3D viewing function is made available (step ST615).

As such, when the 3D image signal is viewed by using the 3D image viewing glasses, the width between the left and right legs 39 of the glasses 30 or the angle A and the angle B are detected. When the detected width or angles A and b are smaller than the reference value (the width of the head is small), it is detected that the user is the child, and the 3D viewing function at the digital TV broadcast receiving device 10 can be made unavailable to prevent the child from viewing the 3D.

As described above, it is detected whether the adult or the child wears the 3D glasses , and the 3D glasses or the digital TV broadcast receiving device may control the 3D viewing function. Viewing of the 3D image may influence development of the child, and the attention is called through a catalogue or an instruction manual so as to prevent the child from viewing the 3D image by means of a 3D viewing apparatus. The present invention prevents the child from viewing the 3D image more certainly by installing a function of limiting the viewing on the apparatus as well as calling the attention.

In the exemplary embodiment, the 3D viewing function is controlled at the 3D glasses or the digital TV broadcast receiving device, but since even the adult may have a small head, the user may change the available or unavailable condition through a setting menu.

Although several exemplary embodiments of the present invention have been described, the exemplary embodiments are presented as an example and do not intend to limit the scope of the present invention. These new exemplary embodiments can be implemented in other various forms and various omissions, replacements, and changes can be made without departing from the spirit and scope of the present invention. The exemplary embodiments or modifications thereof are included in the spirit of the present invention, and included in the scope equivalent to the present invention described in the appended claims.

What is claimed is:

1. A 3D glasses apparatus for displaying a 3D image comprising:
a measurement module configured to measure the size of a user's head by using left and right legs of the 3D glasses apparatus when a user uses the 3D glasses apparatus; and
a detection module configured to detect whether a measurement value measured by the measurement module is smaller than a reference value; and
a controller configured to control a 3D image signal not to display the 3D image in accordance with the judgment result of the detection module.

2. The 3D glasses apparatus according to claim 1, wherein the measurement module is a pressure sensor configured to measure a width between the left and right legs of the 3D glasses apparatus.

3. The 3D glasses apparatus according to claim 1, wherein the measurement module is an angle sensor configured to measure angles between a lens surface and the legs of 3D glasses apparatus.

4. The 3D glasses apparatus according to claim 1, further comprising a frame, wherein the measurement modules are separated from each other in a horizontal direction of the 3D glasses apparatus and fixed to the frame.

5. The 3D glasses apparatus according to claim 1, wherein when the measurement value is smaller than the reference value, the controller prevents displaying of the 3D image by controlling opening and closing of a shutter of the 3D glasses apparatus based on a shutter control signal transmitted from an external main body device.

6. A 3D image display apparatus for displaying a 3D image comprising:
an image output module configured to output the 3D image on a screen; and
a main-body controller configured to receive a notification that a user of the 3D glasses apparatus is a child from the 3D glasses apparatus and configured to prevent generating of a shutter control signal for controlling a shutter of the 3D glasses apparatus when the main-body controller receives the notification.

7. The 3D image display apparatus according to claim 6, wherein the main- body controller controls the image output module not to output the 3D image when the main- body controller receives the notification.

8. A control method of a 3D image display apparatus for displaying a 3D image comprising:
outputting the 3D image on a screen; and
preventing generating of a shutter control signal for controlling a shutter of the 3D glasses apparatus when receiving a notification that a user of the 3D glasses apparatus is a child from the 3D glasses apparatus.

9. The control method of the 3D image display apparatus according to claim 8, further comprising preventing outputting the 3D image from the image output module when receiving the notification from the 3D glasses apparatus.
